(19) United States
(12) Patent Application Publication
(10) Pub. No.: US 2024/0106049 A1
(43) Pub. Date: Mar. 28, 2024

(54) BATTERY CASE

(71) Applicant: ISUZU MOTORS LIMITED, Yokohama-shi (JP)

(72) Inventors: Yoshinori GOTO, Fujisawa-shi (JP); Toshiyuki SEKI, Fujisawa-shi (JP); Takayuki MITA, Fujisawa-shi (JP); Kouji HASHIMOTO, Fujisawa-shi (JP)

(21) Appl. No.: 18/242,761

(22) Filed: Sep. 6, 2023

(30) Foreign Application Priority Data
Sep. 26, 2022 (JP) 2022-153153

(51) Int. Cl. H01M 50/233; H01M 50/209; H01M 50/249

(52) U.S. Cl. CPC H01M 50/233; H01M 50/209; H01M 50/249

(57) ABSTRACT

A battery case of the present disclosure includes a lower case for housing a battery with the upper side of the lower case opened; and an upper case provided on the upper side of the lower case to cover the battery. The lower case includes a lower case bottom surface on which the battery is placed and a lower case side surface extending upward from the edge of the lower case bottom surface. The lower case side surface includes, on its side where a module terminal of the battery is disposed, a cut part cut downward in such a way that the height of the lower case side surface becomes lower than the height of a position of the module terminal.

### CROSS REFERENCE TO RELATED APPLICATIONS

This application is entitled to the benefit of Japanese Patent Application No. 2022-153153, filed on Sep. 26, 2022, the disclosure of which including the specification, drawings and abstract is incorporated herein by reference in its entirety.

### TECHNICAL FIELD

The present disclosure relates to a battery case having a two-part structure and including a box-shaped lower case—for housing a battery—with the upper side thereof opened and an upper case provided on the upper side of the lower case to cover the battery.

### BACKGROUND ART

In recent years, in the field of commercial vehicles such as automobiles and trucks, electrified vehicles such as electric vehicles (EV) that use only a motor as a drive source and hybrid electric vehicles (HEV) that use both an engine and a motor as drive sources have been developed from the viewpoint of reducing environmental load. Such an electrified vehicle is equipped with a large-capacity battery for operating the motor.

A battery case for housing a battery is provided, for example, under the floor of an electric vehicle (EV), a hybrid electric vehicle (HEV), or a plug-in hybrid vehicle (PHV). A battery case disclosed in Patent Literature (hereinafter, referred to as PTL) 1 is known as such a battery case for housing a large-capacity battery.

The battery case of PTL 1 is a component that forms a battery pack. This battery pack is applied to a relatively small electric vehicle, and includes a plurality of battery modules housed in a substantially rectangular battery case. The battery case is configured to be divided into a lower case forming the lower half and an upper case forming the upper half. The lower and upper cases are each integrally cast to have a dish shape by using a metal material such as an aluminum alloy so as to have sufficient rigidity. The lower case and upper case are assembled integrally by bringing the respective peripheral flanges to abut against each other and fastening bolts (not illustrated).

The battery case has a rectangular shape in plan view, and is mounted on a vehicle with its long sides oriented along the direction of travel of the vehicle. For example, the battery case is attached to the lower surface of the vehicle floor along a floor tunnel part provided along the front-back direction of the vehicle in the central part of the vehicle floor.

### CITATION LIST

### Patent Literature

PTL 1
Japanese Patent No. 6616103

### SUMMARY OF INVENTION

### Technical Problem

In several cases, such as building a new battery pack, maintaining a battery, and replacing only a battery and reusing a battery case, some work is required such as connecting and disconnecting a cord (harness) to the module terminal of a battery while the battery is still housed in a battery case.

A battery is provided with a module terminal on its side surface for electrical connection. A connector and a safety plug are disposed on a battery pack on the side surface of a battery case for electrical connection with the outside. The height of the side surface of the battery case where such a connector and a safety plug are disposed is higher than the position of a module terminal in the battery case. According to the technique of PTL 1, a module terminal is provided on the side of a battery so as to face laterally, and the height of the side surface of the lower case is constant and higher than the position of the module terminal of the battery mounted on the bottom of the lower case. Therefore, for connecting a cord to the module terminal of the battery, the side surface of the lower case becomes an obstacle, making it difficult to connect and disconnect the cord (harness) to the module terminal of the battery.

From the view point above, an object of the present disclosure is to provide a battery case having a two-part structure and including a lower case and an upper case, and the battery case can improve work efficiency such as connecting a cord to the battery.

### Solution to Problem

In order to achieve the above object, a battery case in the present disclosure includes: a lower case for housing a battery with the upper side of the lower case opened; and an upper case provided on the upper side of the lower case to cover the battery, in which the lower case includes a lower case bottom surface and a lower case side surface extending upward from an edge of the lower case bottom surface, the lower case bottom surface being configured to house the battery, and the lower case side surface includes, on a side thereof, a cut part cut downward in such a way that a height of the lower case side surface becomes lower than a height of a position of a module terminal of the battery, the side being a side where the module terminal is disposed.

In such a configuration, the lower case side surface includes, on its side where a module terminal of the battery is disposed, a cut part cut downward in such a way that a height of the lower case side surface becomes lower than the height of the position of the module terminal. As a result, the lower case side surface does not become an obstacle during connecting of a cord to the module terminal, thereby facilitating the connecting. Therefore, a battery case having a two-part structure and including a lower case and an upper case can be provided, and the battery case can improve work efficiency such as connecting a cord to the battery.

Preferably, the lower case side surface includes a connector side surface provided with a connector to be connected to an outside of the battery; and a cut part side surface provided with the cut part includes an inclined part connected to the connector side surface.

In such a configuration, the cut part side surface provided with the cut part includes the inclined part connected to the connector side surface, thus has no steep step. This configuration thus allows the periphery of the lower case and the periphery of the upper case to be smoothly abutted against each other without a gap, thereby improving sealing performance.

Preferably, the height of the connector side surface is higher than the height of the cut part; and the inclined part is inclined from the cut part side surface toward an upper end of the connector side surface.

In such a configuration, the inclined part is inclined upward toward the upper end of the connector side surface. Therefore, for abutting the upper case against the lower case from above, the inclined part guides the upper case in a front-back direction of the upper case to facilitate the abutting, thereby improving sealing performance.

Preferably, a plurality of the cut parts are formed to face each other on both sides of the lower case in a width direction of the lower case with the connector side surface located between the cut parts; a width between the cut parts is set larger than a width of the connector side surface; and the inclined part is inclined so as to approach the connector as the inclined part approaches the connector side surface.

In such a configuration, the inclined part inclined in plan view so as to approach the connector as the inclined part approaches the connector side surface. Therefore, for abutting the upper case against the lower case from above, the inclined part guides the upper case in a left-right direction (that is, the width direction of the lower case) to facilitate the abutting, thereby improving sealing performance.

Preferably, the lower case side surface includes a connector side surface provided with a connector to be connected to an outside of the battery; and the connector side surface includes an inclined part connected to a cut part side surface provided with the cut part.

In such a configuration, the connector side surface includes the inclined part connected to the cut part side surface provided with the cut part. Therefore, at least one of the front side surface and the rear side surface of the battery case may be provided with the inclined part to improve the degree of freedom in design.

### Advantageous Effects of Invention

The present disclosure can provide a battery case having a two-part structure and including a lower case and an upper case, and the battery case can improve work efficiency such as connecting a cord to the battery.

### BRIEF DESCRIPTION OF DRAWINGS

FIG. 1 is a partially see-through front view of a battery pack with a battery case according to an embodiment of the present disclosure;

FIG. 2 is a partially see-through rear view of the battery pack with the battery case according to the embodiment of the present disclosure;

FIG. 3 is a partially see-through perspective view of the battery pack with the battery case according to the embodiment of the present disclosure; and

FIG. 4 is a plan view of the battery pack with the battery case according to the embodiment of the present disclosure.

### DESCRIPTION OF EMBODIMENTS

At least one embodiment of the present disclosure will be described below based on the accompanying drawings. The drawings conceptually (schematically) illustrate a schematic configuration of an example of a battery pack with a battery case according to the present disclosure.

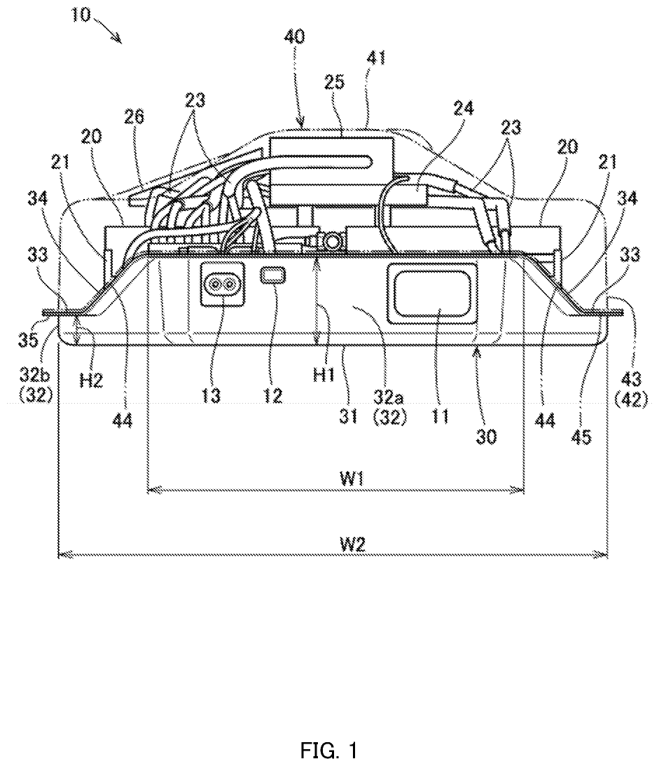

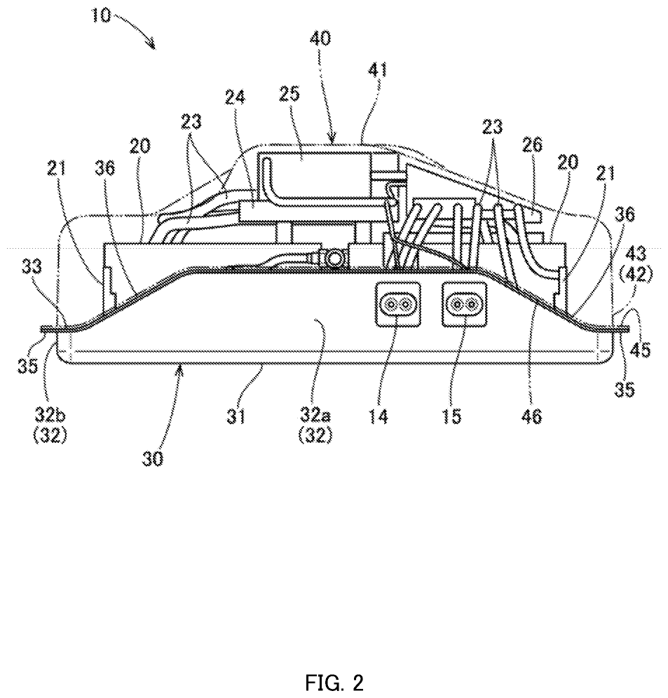

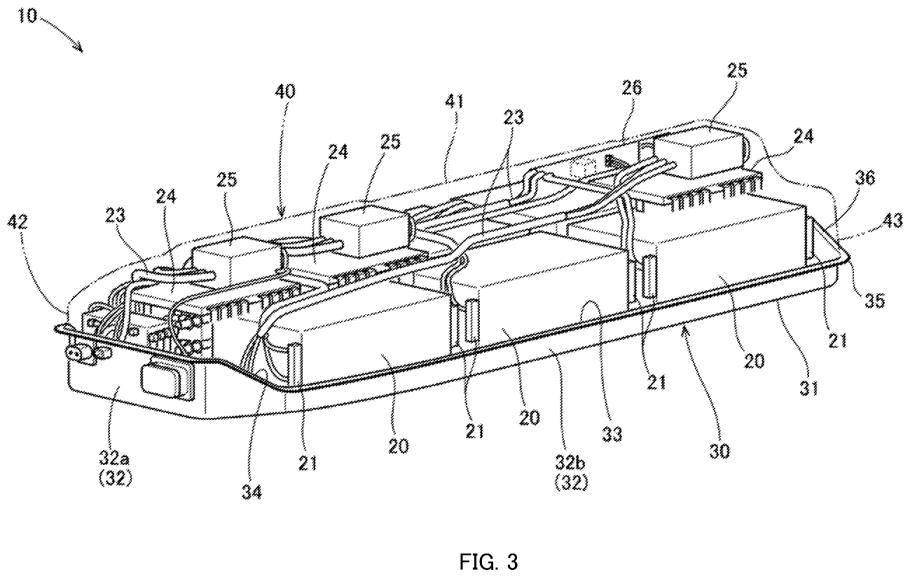

As illustrated in FIGS. 1 to 3, battery pack 10 is configured to be disposed under the floor of an electrified vehicle such as an electric vehicle (EV) that uses only a motor as a drive source, a hybrid electric vehicle (HEV) that uses both an engine and a motor as drive sources, or a plug-in hybrid vehicle (PHV) having an external charging function in addition to these drive sources. The battery pack is configured by connecting a plurality of battery modules (hereinafter referred to as batteries) 20 composed of a plurality of cells or the like via cords 23, and gathering the modules into a lower case 30 and an upper case 40 that serve as a battery case.

The battery case is formed by combining lower case 30 and upper case 40. The battery case has a two-part structure and is composed of box-shaped lower case 30 for housing battery 20, and upper case 40 for covering batteries 20 and the like. The upper side of lower case 30 is opened, and upper case 40 is provided on the upper side of lower case 30.

Battery pack 10 includes a plurality of batteries 20, module terminals 21, cords 23, control management parts 24, current sensor boxes 25, upper terminal 26, and upper case 40 covering them from above. Battery 20 is mounted in lower case 30 and having a power storage function, module terminal 21 is provided to battery 20 for electrical connection, cord 23 is connected to module terminal 21 and other electric parts for energization, control management part 24 is provided above battery 20 for electrical control, current sensor box is provided on the upper side of control management part 24, and upper terminal 26 is provided in the vicinity of at least one of current sensor boxes 25.

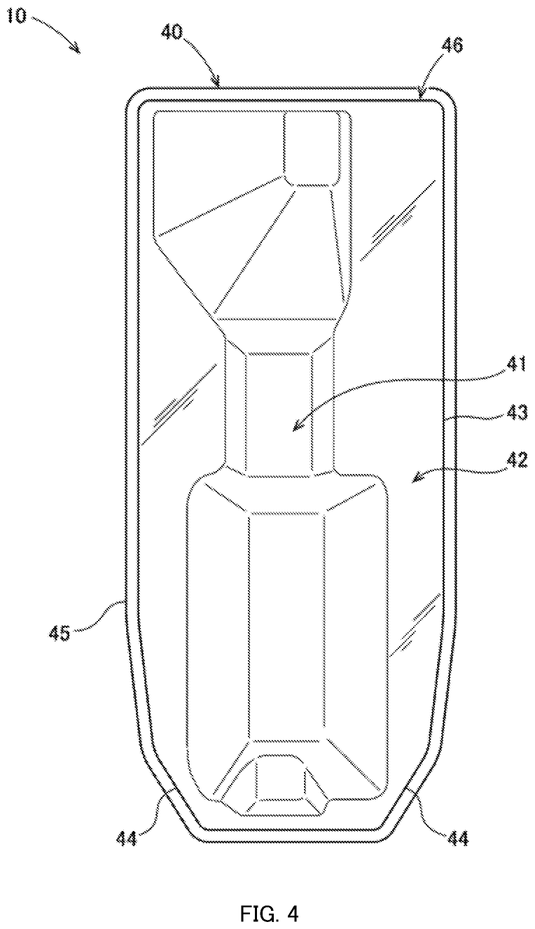

In battery pack 10, connector A 11, connector B 12, and connector C 13 are provided on the front side of lower case 30, and connector D 14 and connector E 15 are provided on the rear side of lower case 30. The shape of battery pack 10 is substantially rectangular in plan view as illustrated in FIG. 4.

In the following, lower case 30 of the battery case will be described. Lower case (battery case) 30 includes lower case bottom surface (i.e., bottom surface of the lower case) 31, on which battery 20 is placed, and lower case side surface (i.e., side surface of the lower case) 32 rising upward from the edge of lower case bottom surface 31. Lower case side surface 32 includes, on its side where module terminals 21 of batteries 20 are disposed, cut part 33 cut downward in such a way that height H2 of lower case side surface 32 becomes lower than the height of the positions where the lower parts of module terminals 21 are located.

As a result, lower case side surface 32 does not become an obstacle during connecting cord 23 to module terminal 21, thereby facilitating the connecting. Therefore, even with battery cases 30 and 40 having a two-part structure composed of lower case 30 and upper case 40, the working efficiency of connecting cord 23 to battery 20 and the like can be improved.

In addition, lower case side surface 32 includes the following: side surfaces for connectors (herein also referred to as “connector side surface”) 32a provided with connectors (connector A 11, connector B 12, connector C 13, connector D 14, and connector E 15) to be connected to the outside of batteries 20; and side surfaces for a cut part (herein also referred to as “cut part side surface”) 32b each provided with cut part 33.

On the front side of lower case 30, cut part side surface 32b of lower case side surface 32 is provided with inclined part 34 connected to connector side surface 32a.

In lower case side surface 32, height H1 of connector side surface 32a is set higher than height H2 of cut part 33. Inclined part 34 is inclined upward from cut part side surface 32b toward the upper end of connector side surface 32a.

Cut parts 33 are formed to face each other on both sides of lower case 30 in the width direction thereof with connector side surface 32a located between the cut parts. Width W2 between two cut parts 33 formed to face each other is set larger than width W1 of connector side surface 32a.

As illustrated in FIGS. 1 to 4, inclined part 34 is inclined so as to approach the connectors as the inclined part approaches the connector side surface in plan view. Inclined part 34 matches upper inclined part 44 of upper case 40 in plan view. Inclined part 34 and upper inclined part 44 are inclined so as to approach the connectors (connector A 11, connector B 12, and connector C 13) as the inclined parts approach connector side surface 32a in plan view. In addition, flange 35 extending outward over the entire circumference is formed at the upper end part of lower case side surface 32.

In the following, the rear side of lower case 30 will be described.

Lower case side surface 32 includes connector side surface 32a provided with connectors (connector A 14 and connector B 15) to be connected to the outside of batteries 20.

On the rear side of lower case 30, connector side surface 32a includes rear side inclined part (i.e., inclined part on the rear side) 36 connected to cut part side surface 32b provided with cut part 33. Rear side inclined part 36 is inclined upward from cut part side surface 32b toward the upper end of connector side surface 32a in a rear view. Rear side inclined part 36 matches rear side upper inclined part (i.e., upper inclined part on the rear side) 46 of upper case 40 in plan view. Rear side inclined part 36 and rear side upper inclined part 46 are each formed linearly without being inclined in plan view.

In the following, upper case 40 of the battery case will be described.

Upper case (battery case) 40 includes upper case upper surface (i.e., upper surface of the upper case) 41, upper case side surface (i.e., side surface of the upper case) 42 and an upper extension surface 43. Upper case upper surface 41 has a convex shape and is formed to be elongated along the longitudinal direction of battery pack 10, upper case side surface 42 is formed downward from the outer circumference of upper case upper surface 41, and upper extension surface 43 is part of upper case side surface 42 and extending downward so as to match cut part 33 of lower case 30.

Upper case 40 further includes upper inclined part 44, rear side upper inclined part 46, and flange 45. Upper inclined part 44 is formed to match inclined part 34 of lower case 30, rear side upper inclined part 46 is formed to match rear side inclined part 36 of lower case 30, and flange 45 extends outward along the entire circumference of the lower end of upper case side surface 42 (including upper extension surface 43) and is configured to be fitted to flange 35 of lower case 30.

Battery pack 10 is disposed in a narrow space, for example, at the bottom of an electrified vehicle; thus, it is preferable to reduce the height of the battery pack in the up-down direction as much as possible. In is regard, upper case 40 of the present embodiment is shaped in such a way that only a part—where control management parts 24 and current sensor boxes 25 are disposed, and thus the part has an increased height in the up-down direction—is raised in a convex shape and the height of the remaining part is limited as small as possible. Therefore, a space for battery 20 can be increased.

Effects of battery pack 10 described above will be described.

According to the present embodiment, lower case side surface 32 includes, on the side thereof where module terminals 21 of batteries 20 is disposed, cut part 33 cut downward in such a way that height H2 of lower case side surface 32 becomes lower than the heights of the positions where the lower parts of module terminals 21 are located. As a result, lower case side surface 32 does not become an obstacle during connecting cord 23 to module terminal 21, thereby facilitating the connecting. Therefore, the present embodiment can provide a battery case (a combination of battery cases 30 and 40), specifically, battery cases and 40 having a two-part structure composed of lower case 30 and upper case 40, which is capable of improving the working efficiency of connecting cord 23 to battery 20, and the like.

In addition, cut part side surface 32b provided with cut part 33 includes inclined part 34 and a rear side inclined part 36 each connected to connector side surface 32a, thus has no steep step. This configuration allows the periphery of lower case 30 and the periphery of upper case 40 to be smoothly abutted against each other without a gap, thereby improving sealing performance.

Front side inclined part 34 is inclined upward toward the upper end of connector side surface 32a. Therefore, for abutting upper case 40 against lower case 30 from above, inclined part 34 guides upper case 40 in the front-back direction of the upper case to facilitate the abutting, thereby improving sealing performance.

Front side inclined part 34 inclined so as to approach the connectors (connector A 11, connector B 12, and connector C 13) as the inclined part approaches connector side surface 32a in plan view. Therefore, for abutting upper case 40 against lower case 30 from above, inclined part 34 guides upper case 40 in the left-right direction (that is, the width direction of the lower case) to facilitate the abutting, thereby improving sealing performance.

Connector side surface 32a includes inclined parts 34 and 36 each connected to cut part side surface 32b provided with cut part 33. Therefore, at least one of the front side and the rear side of battery cases 30 and 40 may be provided with inclined parts 34 and 36 to improve the degree of freedom in design.

In the present embodiment, cut parts 33 are provided on both the left and right sides of battery pack 10; however, the present disclosure is not limited thereto. When module terminals 21 of batteries 20 are disposed only on either the left or right side of battery pack 10, cut part 33 may be formed only on the one side where module terminals 21 are disposed.

In the present embodiment, the shape of battery pack 10 is substantially rectangular in plan view; however, the present disclosure is not limited thereto. The shape of battery pack 10 may be square, circular, or the like in plan view, and the shape of battery pack 10 may be changed according to the battery disposition space of an electrified vehicle to be equipped with battery pack 10.

That is, the present disclosure is not limited to the present embodiment as long as the actions and effects of the present disclosure are achieved.

### INDUSTRIAL APPLICABILITY

The present disclosure is suitably used for battery cases including the following: a lower case for housing a battery with the upper side of the lower case opened; and an upper case provided on the upper side of the lower case to cover the battery.

1. A battery case, comprising:
a lower case for housing a battery, wherein an upper side of the lower case is opened; and
an upper case provided on the upper side of the lower case to cover the battery, wherein
the lower case includes a lower case bottom surface, on which the battery is placed, and a lower case side surface extending upward from an edge of the lower case bottom surface, and
the lower case side surface includes, on a side thereof, a cut part cut downward in such a way that a height of the lower case side surface becomes lower than a height of a position of a module terminal of the battery, the side being a side where the module terminal is disposed.

2. The battery case according to claim 1, wherein:
the lower case side surface includes a connector side surface provided with a connector to be connected to an outside of the battery; and
a cut part side surface provided with the cut part includes an inclined part connected to the connector side surface.

3. The battery case according to claim 2, wherein:
a height of the connector side surface is higher than a height of the cut part; and
the inclined part is inclined from the cut part side surface toward an upper end of the connector side surface.

4. The battery case according to claim 2, wherein:
a plurality of the cut parts are formed to face each other on both sides of the lower case in a width direction of the lower case with the connector side surface located between the cut parts;
a width between the cut parts is set larger than a width of the connector side surface; and
the inclined part is inclined so as to approach the connector as the inclined part approaches the connector side surface.

5. The battery case according to claim 1, wherein:
the lower case side surface includes a connector side surface provided with a connector to be connected to an outside of the battery; and
the connector side surface includes an inclined part connected to a cut part side surface provided with the cut part.
